(19) United States
(12) Patent Application Publication
(10) Pub. No.: US 2014/0136943 A1
(43) Pub. Date: May 15, 2014

(54) RENDERING WEB CONTENT WITHIN DOCUMENTS

(71) Applicant: MICROSOFT CORPORATION, Redmond, WA (US)

(72) Inventors: Russell Spencer Alexander Palmer, Seattle, WA (US); Brian Michael Jones, Redmond, WA (US); Rolando Jimenez-Salgado, Redmond, WA (US); Alexandru Croicu, Redmond, WA (US); Rajanikanth Naduppalayam Thandavan, Bellevue, WA (US)

(73) Assignee: MICROSOFT CORPORATION, Redmond, WA (US)

(21) Appl. No.: 13/672,726

(22) Filed: Nov. 9, 2012

(51) Int. Cl. G06F 17/00

(52) U.S. Cl. 715/234

(57) ABSTRACT

Concepts and technologies are described herein for rendering web content within documents. In accordance with some of the concepts and technologies disclosed herein, a method includes presenting a web add-in within a document. The web add-in includes a container in which web content can be provided within the document. The method may include receiving an input and, in response to the input, capturing a static image that is representative of the web content at a time instance after the input. The method may include receiving a request to copy the web add-in and, in response to the request to copy the web add-in, executing a copy operation. The method may also include receiving a request to paste the web add-in and, in response to the request to paste the web add-in, pasting the web add-in or the static image based upon the paste target.

### BACKGROUND

Word processing applications, spreadsheet applications, presentation applications, and other productivity applications allow users to create documents for personal, business, educational, and other purposes. Software developers may desire to create ways by which users can use productivity applications to enrich their documents with web-based content. Web-based content has a high penchant for change and is susceptible to being interrupted or rendered unavailable if online connectivity is reduced or lost. Moreover, providing web-based content in documents introduces complications with regard to print preview, print to file, print to printer, backwards compatibility, cut, copy, paste, and other functionality.

It is with respect to these and other considerations that the disclosure made herein is presented.

### SUMMARY

Concepts and technologies are described herein for rendering web content within documents. According to one aspect, a method includes presenting a web add-in within a document. The web add-in may include a container in which web content can be provided within the document. The method may also include receiving an input and, in response to the input, capturing a static image that is representative of the web content at a time instance after the input. In some embodiments, the input includes a request to save the document, a request to print the document to a printer device, a request to print the document to a file, a request to enter a print preview mode, a request to enter an advanced view in which two or more instances of the web add-in are provided, a request to enter a read-only mode of the web add-in compatible application, a request to cut the web add-in from the document, or a request to copy the web add-in. In any case, the input may cause the capture of a static image of the web add-in so that a “snapshot” of what the web content presented within the web add-in is viewable in a saved version of the document, a printed version of the document, a new file to which the document is saved, an advanced view, a read-only mode, or a pasted instance of the web add-in after a cut or copy operation is performed.

According to another aspect, a method includes presenting a web add-in within a document, receiving a request to copy the web add-in, and in response to the request, executing a copy operation. The method may also include receiving a request to paste the web add-in into a new location within the document, a request to paste the web add-in into a different document that has been opened using the same application as the document, a request to paste the web add-in into a different document that has been opened using a different application that supports web add-ins, or a request to paste the web add-in into a different document that has been opened using a different application that does not support web add-ins.

According to yet another aspect, a method includes presenting a web add-in within a document, receiving a request to copy the web add-in, executing a capture operation to capture a static image of the web content, executing a copy operation to copy the web add-in, receiving a request to paste the web add-in, and executing a paste operation. The paste operation may include pasting the web add-in if the paste target is capable of presenting the web add-in or pasting the static image if the paste target is incapable of presenting the web add-in.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram illustrating an illustrative operating environment for implementing various embodiments presented herein.

FIG. 2 is a state diagram illustrating various states of a web add-in, according to an illustrative embodiment.

FIG. 3 is a flow diagram illustrating aspects of a method for capturing a static image of a web add-in, according to an illustrative embodiment.

FIG. 4 is a flow diagram illustrating aspects of a method for copying a web add-in, according to an illustrative embodiment.

FIGS. 5-9 are flow diagrams illustrating aspects of methods for copying and pasting web add-ins, according to illustrative embodiments.

FIG. 10 is a computer architecture diagram illustrating illustrative computer hardware and software architecture for a computing system capable of implementing aspects of the embodiments presented herein.

FIG. 11 is a diagram illustrating a distributed computing environment capable of implementing aspects of the embodiments presented herein.

FIG. 12 is a computer architecture diagram illustrating a computing device architecture capable of implementing aspects of the embodiments presented herein.

### DETAILED DESCRIPTION

The following detailed description is directed to concepts and technologies for rendering web content within documents. In accordance with some embodiments disclosed herein, web-based software applications extensions provide a new extensibility model for productivity applications such as those included in productivity application suites like MICROSOFT OFFICE, available from Microsoft Corporation of Redmond, Wash. This new extensibility model allows a broad audience of web application developers to easily create web-based solutions that extend the functionality of productivity applications with web content. Although the following detailed description focuses on extending the functionality of productivity applications, the web-based software application extensions can be used to extend the functionality of other applications, such as multimedia applications, photography applications, design applications, video game applications, and others.

The web-based software application extensions are generally referred to herein as “web add-ins.” A web add-in provides a region containing a web page within an application. The web add-in provides new and interactive content types and functionality. Like web pages, web add-ins can be built using standard web technologies such as, but not limited to, hypertext markup language (“HTML”), Javascript, and representational state transfer (“REST”). In contrast with existing extensibility technologies like add-ins and visual basic for applications (“VBA”), web add-ins enable a single codebase to run on multiple environments, including rich client applications, mobile phone applications, tablet applications, and applications configured to run on various personal computer (“PC”) operating systems, such as MICROSOFT WINDOWS, available from Microsoft Corporation of Redmond, Wash., and APPLE MAC OS, available from Apple Inc. of Cupertino, Calif. Web add-ins can be acquired by end users from a virtual marketplace or from collaboration platform websites, such as websites developed using MICROSOFT SHAREPOINT, available from Microsoft Corporation of Redmond, Wash., in the form of stand-alone extensions or subcomponents of document template solutions or applications.

Web add-ins can be configured to do or provide, within a document, anything a web page can do or provide. For instance, web add-ins can provide an interactive user interface (“UI”), custom logic through dynamic HTML (“DHTML”) and/or Javascript, leverage Javascript frameworks like JQuery, connect to REST/Web services via HTTP/AJAX, and/or host controls provided in ADOBE FLASH, available from Adobe Systems of San Jose, Calif., MICROSOFT SILVERLIGHT, available from Microsoft Corporation of Redmond, Wash., or other application frameworks for developing rich web-based applications and content. In addition to providing the functionality of a web page or other web content within a document, web add-ins can interact with a hosting application through a Javascript library that provides application programming interfaces (“APIs”) for reading and writing to documents as well as handling key application and user events like selection change.

In some embodiments, a web add-in includes a reference to and a description of a web server that is capable of providing a web page and/or web service. The reference to and description of the web server is referred to herein as a web add-in manifest, or simply a manifest. The web page and/or web service can be added to a document or an application through a web add-in.

A virtual marketplace is provided that facilitates users to browse, search, and choose from available manifests. One or more web servers are also provided for powering web add-ins. In some embodiments, the web servers are hosts to download files, such as HTML and/or Javascript files). In some embodiments, the web servers provide a set of web services that connect to a rich back-end that includes server-side logic.

For ease of illustration and description, a web add-in is used herein, at times, to collectively refer to a manifest and the ability for a web server to provide one or more of the following: (1) one or more HTML files; (2) one or more Javascript files; and (3) one or more web services to access server-side functionality and content that add value to a document or application. Alternatively, a web add-in may refer to a manifest and the ability for a web server to provide one or more files based upon any other web technology or any combination of web technologies and one or more web services to access server-side functionality and content that add value to a document or application.

In some embodiments disclosed herein, web add-ins are embedded in documents such as word processing documents, spreadsheet documents, presentation documents, email, and the like. In these embodiments, the web add-ins are referred to as content web add-ins. Content web add-ins enable web pages or portions thereof to become part of a document as embedded content that can be shown inline, wrapped, over, or behind the contents of the document. Content web add-ins can enable embedded media scenarios like video players and picture galleries as part of the document, as well as general external content capabilities.

In some embodiments disclosed herein, web add-ins provide the ability to surface web content on a bigger canvas, thus enabling rich dashboard and process context scenarios. In these embodiments, the web add-ins are referred to as backstage web add-ins.

In some embodiments disclosed herein, web add-ins provide web content within a task pane. A task pane, in some embodiments, is used herein to describe a dockable dialog window within an application user interface. A task pane web add-in allows scenarios where users benefit from seeing supplemental information to the document on which they are currently working, which enhances their ability to perform work. This information may relate to data in a document, such as additional contact information related to a business customer, or may provide extra guidance, such as via a dictionary or encyclopedia. Task pane web add-ins can also extend application capabilities by allowing users to perform actions and submit entries to other systems and services, thereby reducing the need for multiple application contexts and improving the use and benefit of an application or application suite.

In some embodiments disclosed herein, web add-ins allow a user to select a portion of a document (e.g., a cell within a spreadsheet or a sentence in a word processing document) and, through a contextual menu, get access to one or more web add-ins that can provide information or functionality based upon the selection. In these embodiments, the web add-ins are referred to as floating web add-ins. Floating web add-ins can be transient. In other words, floating web add-ins can disappear after a user clicks or otherwise interacts with the document.

Floating web add-ins and task pane add-ins are referred to herein as out-of-document web add-ins. Other types of out-of-document web add-ins include ribbon web add-ins, menu web add-ins, toolbar add-ins, status bar add-ins, popup menu add-ins, or separate applications.

In some embodiments, users that own web add-ins or have trial access to web add-ins can insert them to documents. In some embodiments, any user can insert a web add-in, but may be forced to have some form of advertising appear when using the web add-in. In some embodiments, users are able to insert a web add-in for use in a degraded manner. For instance, a user may be able to insert watermarked images only, or may be able to invoke functionality to perform calculations on limited data sets. Trials in this instance could be used to provide a time-limited free way to access full functionality of a web add-in. In some embodiments, web add-ins are offered free of charge. In any case, the users can then distribute the documents containing the web add-ins to other users, who may or may not be licensed, if applicable, to use the web add-ins. The documents can be distributed in any way that files are distributed. When a user receives a document containing a web add-in, the user can obtain trial rights to the web add-in or purchase the web add-in without having to visit a virtual marketplace.

In some embodiments disclosed herein, web add-ins are contextual. In these embodiments, the web add-in is configured to automatically appear based upon the content included in a document or email.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and in which are shown by way of illustration specific embodiments or examples. Referring now to the drawings, in which like numerals represent like elements throughout the several figures, aspects of a computing system, computer-readable storage medium, and computer-implemented methodology for rendering web content within documents will be presented.

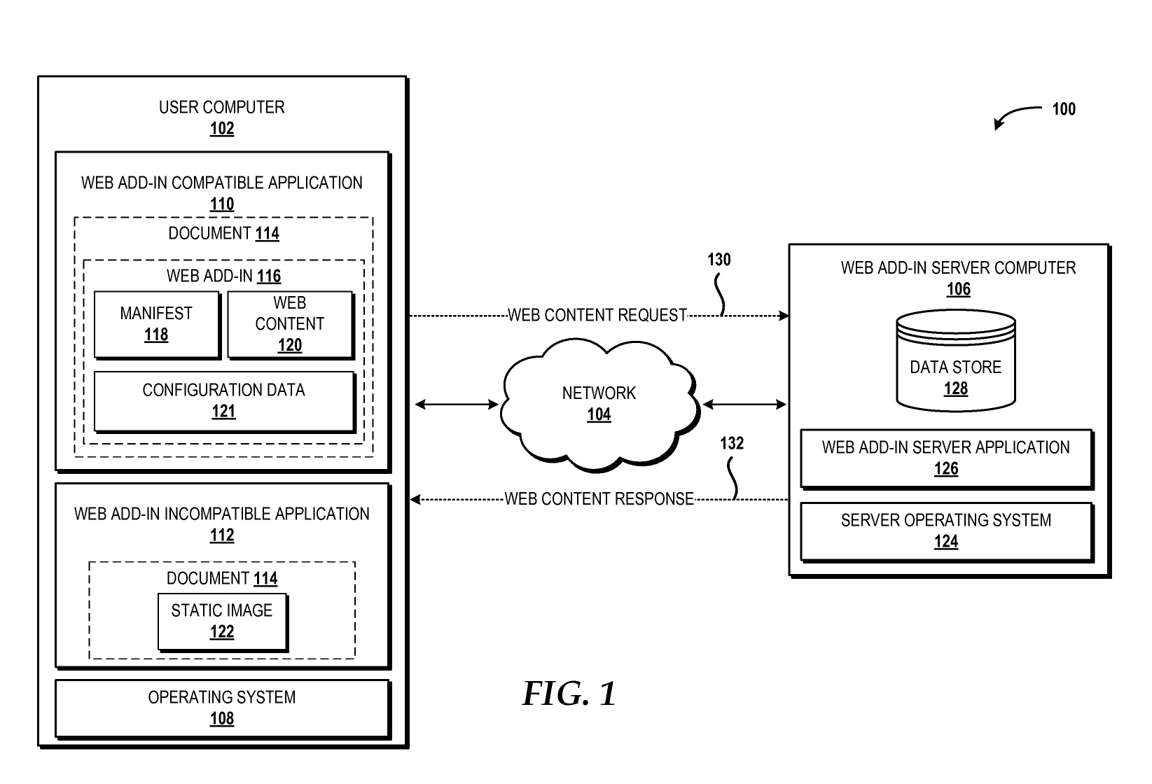

Referring now to FIG. 1, aspects of one operating environment 100 for various embodiments presented herein will be described. The operating environment 100 shown in FIG. 1 includes a user computer 102 operating on or in communication with a network 104. The user computer 102 may be a personal computer (“PC”), desktop workstation, laptop computer, tablet computer, notebook computer, personal digital assistant (“PDA”), electronic-book reader, game console, set-top box, consumer electronics device, server computer, or any other type of computing device configured to perform the various operations described herein for rendering web content within documents. The network 104 may be an internet, the Internet, an intranet, or an extranet. Access to the network 104 may be provided via one or more wired or wireless access networks (not shown), as will be understood by those skilled in the art.

The user computer 102 is configured to communicate with a web add-in server computer 106 over the network 104 to obtain web add-ins and web content for presentation within one or more web add-ins for one or more applications that execute on the user computer 102. In particular, the user computer 102 is configured to execute an operating system 108 and one or more application programs such as, in the illustrated embodiment, a web add-in compatible application 110 and a web add-in incompatible application 112. The operating system 108 is a computer program for controlling the operation of the user computer 102. The web add-in compatible application 110 and the web add-in incompatible application 112 are executable programs configured to execute on top of the operating system 108 to provide various functionality described herein.

The web add-in compatible application 110, when executed by the user computer 102, can open a document 114. The document 114 may be a new document created by the web add-in compatible application 110 or a previously saved document. The illustrated document 114 includes a web add-in 116 that includes a manifest 118 and web content 120. The web add-in 116 may be any type of web add-in described herein above. The web add-in 116 may include a container in which to provide the web content 120 within the document 114.

The web content 120 can include data from a webpage and/or a web service provided by a web server, such as the web add-in server computer 106 and/or one or more other web servers (not shown). The manifest 118, in some embodiments, is an extensible markup language (“XML”) manifest file that points to the web content 120 on the web add-in server computer 106. In some embodiments, the manifest 118 specifies a unique identity and the desired integration behavior of the web add-in 116 within the web add-in compatible application 110. For instance, the manifest 118 can specify the uniform resource locator (“URL”) at which the web content 120 can be accessed, how the web add-in 116 is to be shown (e.g., in a task pane or as embedded content), the application(s) the web add-in 116 supports, and data access requirements, among other details of the web add-in 116. Based upon the details included in the manifest 118 and configuration data 121, the web add-in 116 can be used by the web add-in compatible application 110 to present the web content 120 within the document 114 as a content web add-in and/or a task pane web add-in. Although the manifest 118 and the configuration data 121 are illustrated and described herein as separate components, in some embodiments, the manifest 118 includes the configuration data 121, or vice versa. Other types of web add-ins, such as those described above, may alternatively or additionally be represented in the document 114.

The configuration data 121 can be used to provide details regarding a configuration of the web add-in 116. As such, the configuration data 121 can define the arrangement of the web content 120 in the web add-in 116 and/or data used for the purpose of enabling functionality of the web content 120. For example, if a content web add-in is configured to present a user with a breakdown of a company's sales in Europe over a 12 month period, the configuration data 121 might contain (a) which query a user wanted to execute, such as region=Europe, date_range=365 days, and (b) authentication information, such as a username and password to access the company's account. Alternatively, the configuration data 121 may contain a request for authentication information such as a username and password that can be presented to a user before or during presentation of the web add-in 116. In some embodiments, at least a portion of the web add-in 116 is viewable without the authentication information. In these embodiments, the authentication information may be required for the user to use and/or edit the web add-in 116.

Another example is the ability to bind the configuration data 121 in the document (e.g., a range of cells) to a web service that will act upon them (e.g., run statistical analysis on the range of cells). The configuration data 121 may be associated with a content web add-in, a task pane web add-in, or another type of web add-in, such as described above.

The web add-in compatible application 110 is an application program that is configured to facilitate the incorporation of one or more web add-ins into a document. In some embodiments, the web add-in compatible application 110 is an application such as, but not limited to, a word processing application, spreadsheet application, presentation application, drawing application, photography application, design application, video game application, music application, video application, or a collaboration application. In some embodiments, the web add-in compatible application 110 is MICROSOFT WORD, available from Microsoft Corporation of Redmond, Wash., MICROSOFT EXCEL, available from Microsoft Corporation of Redmond, Wash., MICROSOFT POWERPOINT, available from Microsoft Corporation of Redmond, Wash., MICROSOFT VISIO, available from Microsoft Corporation of Redmond, Wash., or MICROSOFT SHAREPOINT, available from Microsoft Corporation of Redmond, Wash. Alternatively, the web add-in compatible application 110 may be any other application that supports web add-ins. In some embodiments, the web add-in compatible application 110 is an application program that facilitates a user to view web add-ins in documents without the ability to modify the web add-ins.

The web add-in incompatible application 112 is an application program that is incapable of presenting the web add-in 116. In some embodiments, the web add-in incompatible application 112 is an older version of the web add-in compatible application 110 prior to the web add-in functionality being supported. In some embodiments, the web add-in incompatible application 112 is an application such as, but not limited to, a word processing application, spreadsheet application, presentation application, drawing application, photography application, design application, video game application, music application, video application, a file viewer application, or a collaboration application.

The web add-in incompatible application 112, when executed by the user computer 102, can open the document 114. In the illustrated example, the web add-in incompatible application 112 opens the document 114 and presents a static image 122 in lieu of the web add-in 116. The static image 122 is an image that is representative of the web add-in 116. The static image 122 can be in any image format such as, but not limited to, Joint Photographic Experts Group (“JPEG”), Graphics Interchange Format (“GIF”), Tagged Image File Format (“TIFF”), raw image format (“RAW”), or Bitmap format (“BMP”). In some embodiments, the static image 122 is representative of the web content 120 provided within the container of the web add-in 116 at a particular time instance. The time instance can be, but is not limited to, a time instance after the user computer 102 receives an input via the web add-in compatible application 110. For example, after receiving an input to save the document 114 using the web add-in compatible application 110, the static image 122 can be captured, and then, when the document 114 is opened in the web add-in incompatible application 112, the document 114 is presented with the static image 122 instead of the web add-in 116 that the web add-in incompatible application 112 does not support. Other examples of input that can trigger the capture of the static image 122 include, but are not limited to, a request to print the document 114 to a printer device (not shown), a request to print the document 114 to a file, a request to enter a print preview mode of an application, a request to enter an advanced view of an application in which two or more instances of the web add-in 116 can be presented, a request to enter a read-only mode, the receipt of a notification that a data connection through which the web content 120 is received from the web add-in server computer 106 is no longer available, a request to copy the web add-in 116, or a request to cut the web add-in 116. The static image 122, in some embodiments, is presented by the web add-in compatible application 110 within the document 114 alone or in addition to at least one instance of the web add-in 116.

Although the web add-in compatible application 110 and the web add-in incompatible application 112 are shown as residing in the user computer 102, it should be understood that, in some implementations only the web add-in compatible application 110 or only the web add-in incompatible application 112 resides in the user computer 102 at a given time.

The web add-in server computer 106 is configured to execute a server operating system 124 and one or more application programs such as, in the illustrated embodiment, a web add-in server application 126. The server operating system 124 is a computer program for controlling the operation of the web add-in and marketplace server computer 106. The application programs are executable programs configured to execute on top of the server operating system 124 to provide various functionality described herein.

The web add-in server application 126 is configured to enable features of one or more web add-ins, by providing one or more of the following: (1) one or more HTML files; (2) one or more Javascript files; and (3) one or more web services to access server-side functionality and content that add value to a document or application. The HTML files, Javascript files, other files, web content, and other data associated with providing web add-ins can be stored in a data store 128.

The web add-in server application 126 is also configured to receive one or more web content requests 130 from the user computer 102 and to respond to the one or more web content requests 130 by providing one or more web content responses 132. A web content request 130 can include a request generated by the web add-in 116 for the web content 120. The web add-in server application 126 can receive a web content request 130, acquire the requested web content from the data store 128 and/or another data store local or remote to the web add-in server computer 106, and provide the requested web content in a web content response 132 to the user computer 102 for use by the web add-in 116 to present the web content 120 in the document 114.

It should be understood that some implementations of the operating environment 100 include multiple user computer 102, multiple networks 104, multiple web add-in server computers 106, multiple operating systems 108, multiple web add-in compatible applications 110, multiple web add-in incompatible applications 112, multiple documents 114, multiple web add-ins 116, multiple manifests 118, multiple web contents 120, multiple static images 122, multiple server operating systems 124, multiple web add-in server applications 126, multiple data stores 128, multiple web content requests 130, and/or multiple web content responses 132. Thus, the illustrated embodiment should be understood as being illustrative, and should not be construed as being limiting unless otherwise noted.

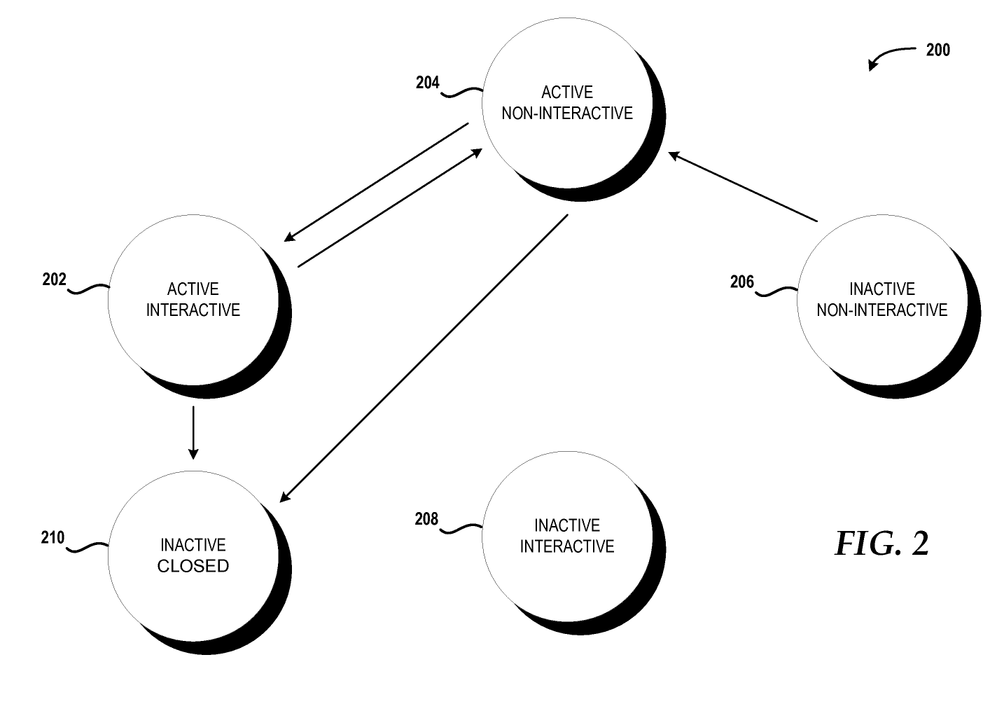

Turning now to FIG. 2, a state diagram 200 illustrating various states of a web add-in, such as the web add-in 116, will be described, according to an illustrative embodiment. The following terms and corresponding definitions are used in the state diagram 200 to describe different states that a web add-in can be in within an application, such as the web add-in compatible application 110. “Active” is used herein to describe a state in which a web add-in is visible and is currently running a control through which the web add-in can receive and process events from a document. “Inactive” is used herein to describe a state in which a web add-in is visible and is not currently running a control. “Interactive” is used herein to describe a state in which a web add-in is visible and one or more controls provided within the web add-in can be interacted with and actions as a result of manipulation of the one or more controls can take effect. “Non-interactive” is used herein to describe a state in which a web add-in is visible and includes a static image. “Closed” is used herein to describe a state in which a web add-in is not visible. “Closed” may also be referred to as “deleted” wherein the web add-in has been deleted from a document. “Hidden” is used herein to describe a state in which a web add-in is neither visible nor interactive, but is still active and can receive and process events through a control.

The state diagram 200 shows an active/interactive state 202, an active/non-interactive state 204, an inactive/non-interactive state 206, an inactive/interactive state 208, and an inactive/closed state 210. From the active/interactive state 202, a web add-in can transition to the active/non-interactive state 204 or to the inactive/closed state 210. From the active/non-interactive state 204, the web add-in can transition to the active/interactive state 202 or the inactive/closed state 210. From the inactive/non-interactive state 206, the web add-in can transition to the active/non-interactive state 204. The inactive/interactive state 208 is not a valid state.

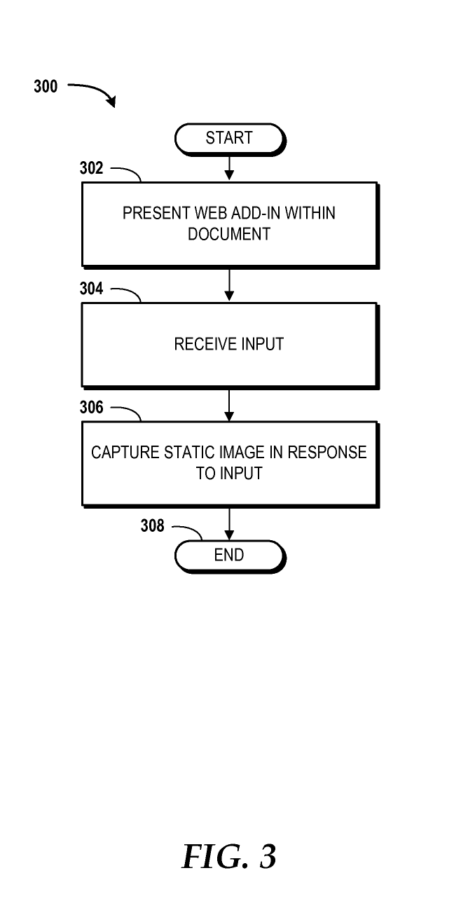

Turning now to FIG. 3, a method for capturing a static image of a web add-in will be described, according to an illustrative embodiment. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can be ended at any time and need not be performed in their respective entireties. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, processor-based, programmable consumer electronics, combinations thereof, and the like.

Thus, it should be appreciated that the logical operations described herein are implemented (1) as a sequence of computer-implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

The method 300 is described with additional reference to FIG. 1. In particular, the method 300 is described as being performed by the user computer 102 executing the web add-in compatible application 110.

The method 300 begins and proceeds to operation 302, wherein the user computer 102 presents the web add-in 116 within the document 114. The web add-in, as described above, includes a container in which to provide the web content 118 within the document 114. From operation 302, the method 300 proceeds to operation 304, wherein the user computer 102 receives an input. In response to receiving the input, the user computer 102, at operation 306, captures a static image such as the static image 122. From operation 306, the method 300 proceeds to operation 308, wherein the method 300 may end.

The input received at operation 304 can include a request to save the document 114, a request to print the document 114 to a printer device, a request to print the document 114 to a file, a request to enter a print preview mode of the web add-in compatible application 110, a request to enter an advanced view of the application in which two or more instances of the web add-in 116 are provided, a request to enter a read-only mode of the web add-in compatible application 110, a request to cut the web add-in 116 from the document 114, or a request to copy the web add-in 116. In any case, the input causes the user computer 102 to capture a static image of the web add-in 116 so that a “snapshot” of what the web content 120 is viewable in a saved version of the document 114, a printed version of the document, a new file to which the document 114 is saved, an advanced view, a read-only mode, or a pasted instance of the web add-in 116 after a cut or copy operation is performed.

The static image can be used by applications, such as the web add-in incompatible application 112, that do not support the web add-in 116 but support images in the same format as the static image. The static image can also be used when the user computer 102 does not have access to the web add-in server computer 106 such as because of network connectivity issues, server maintenance, or for some other reason.

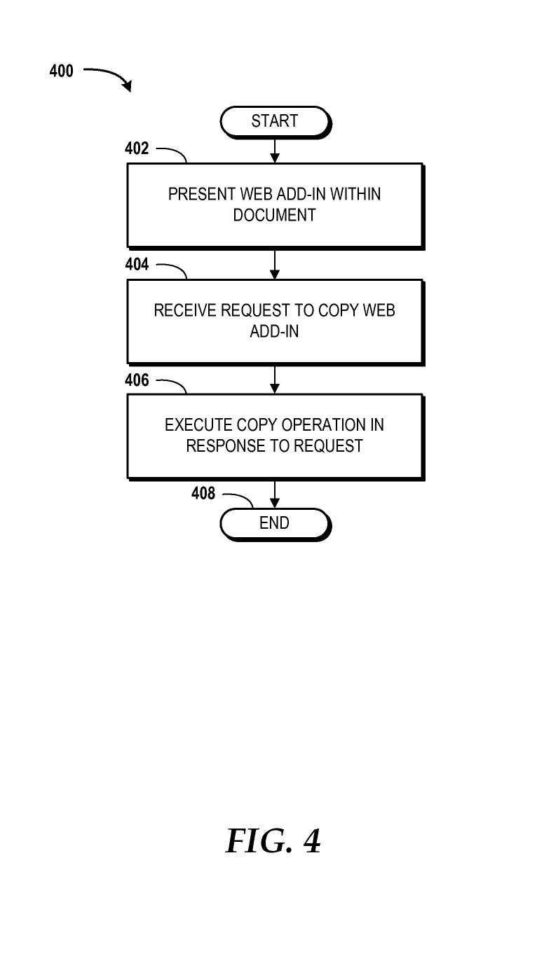

Turning now to FIG. 4, a method 400 for copying a web add-in will be described, according to an illustrative embodiment. The method 400 is described with additional reference to FIG. 1. In particular, the method 400 is described as being performed by the user computer 102 executing the web add-in compatible application 110.

The method 400 begins and proceeds to operation 402, wherein the user computer 102 presents the web add-in 116 within the document 114. The web add-in, as described above, includes a container in which to provide the web content 118 within the document 114. From operation 402, the method 400 proceeds to operation 404, wherein the user computer 102 receives a request to copy the web add-in 116. In response to receiving the request to copy the web add-in 116, the user computer 102, at operation 406, executes a copy operation to copy the web add-in 116. In some embodiments, the copy operation is executed by a copy function provided by the operating system 108. In some other embodiments, the copy operation is executed by a copy operation provided by the web add-in compatible application 110. From operation 406, the method 400 proceeds to operation 408, wherein the method 400 may end.

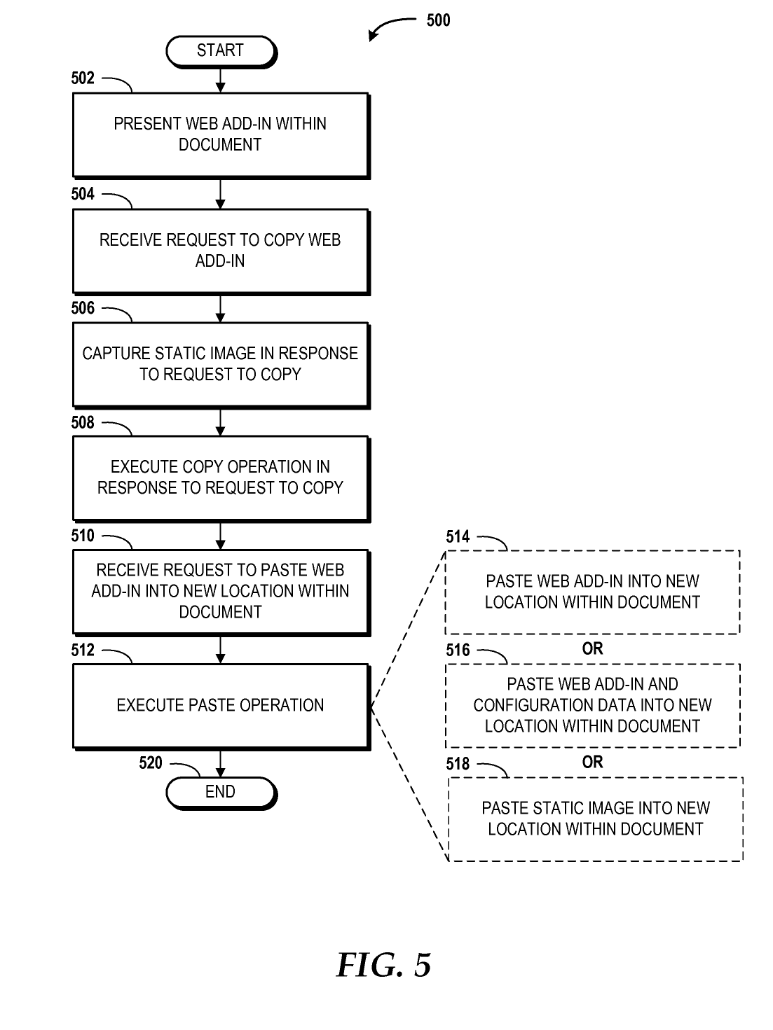

Turning now to FIG. 5, a method 500 for copying and pasting a web add-in will be described, according to an illustrative embodiment. The method 500 is described with additional reference to FIG. 1. In particular, the method 500 is described as being performed by the user computer 102 executing the web add-in compatible application 110.

The method 500 begins and proceeds to operation 502, wherein the user computer 102 presents the web add-in 116 within the document 114. From operation 502, the method 500 proceeds to operation 504, wherein the user computer 102 receives a request to copy the web add-in 116. In response to receiving the request to copy the web add-in 116, the user computer 102, at operation 506, captures a static image of the web add-in 116. Also in response to receiving the request to copy the web add-in 116, the user computer 102, at operation 508, executes a copy operation to copy the web add-in 116. It should be understood that the operations 506, 508 may be performed in parallel or sequentially in any order after receiving the request to copy the web add-in 116.

From operation 508, the method 500 proceeds to operation 510, wherein the user computer 102 receives a request to paste the web add-in 116 into a new location within the document 114. At operation 512, the user computer 102 executes a paste operation. In some embodiments, the paste operation includes pasting the web add-in 116 into the new location within the document 114, as illustrated at operation 514. In some other embodiments, the paste operation includes pasting the web add-in 116 and the configuration data 121 into the new location within the document 114, as illustrated at operation 516. In some other embodiments, the paste operation includes pasting the static image captured at operation 506 into the new location within the document 114, as illustrated at operation 518. The method 500 then proceeds to operation 520, wherein the method 500 may end.

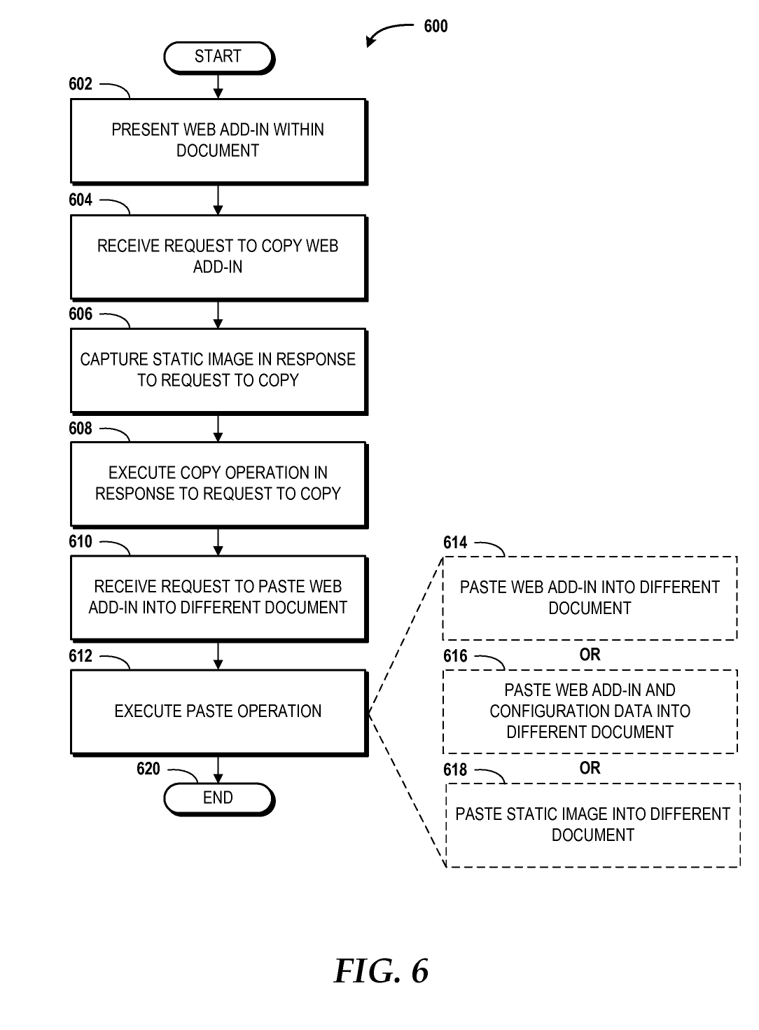

Turning now to FIG. 6, a method 600 for copying and pasting a web add-in will be described, according to an illustrative embodiment. The method 600 is described with additional reference to FIG. 1. In particular, the method 600 is described as being performed by the user computer 102 executing the web add-in compatible application 110.

The method 600 begins and proceeds to operation 602, wherein the user computer 102 presents the web add-in 116 within the document 114. From operation 602, the method 600 proceeds to operation 604, wherein the user computer 102 receives a request to copy the web add-in 116. In response to receiving the request to copy the web add-in 116, the user computer 102, at operation 606, captures a static image of the web add-in 116. Also in response to receiving the request to copy the web add-in 116, the user computer 102, at operation 608, executes a copy operation to copy the web add-in 116. It should be understood that the operations 606, 608 may be performed in parallel or sequentially in any order after receiving the request to copy the web add-in 116.

From operation 608, the method 600 proceeds to operation 610, wherein the user computer 102 receives a request to paste the web add-in 116 into a different document that has been opened using the web add-in compatible application 110. At operation 612, the user computer 102 executes a paste operation. In some embodiments, the paste operation includes pasting the web add-in 116 into the different document, as illustrated at operation 614. In some other embodiments, the paste operation includes pasting the web add-in 116 and the configuration data 121 into the different document, as illustrated at operation 616. In some other embodiments, the paste operation includes pasting the static image captured at operation 606 into the different document, as illustrated at operation 618. The method 600 then proceeds to operation 620, wherein the method 600 may end.

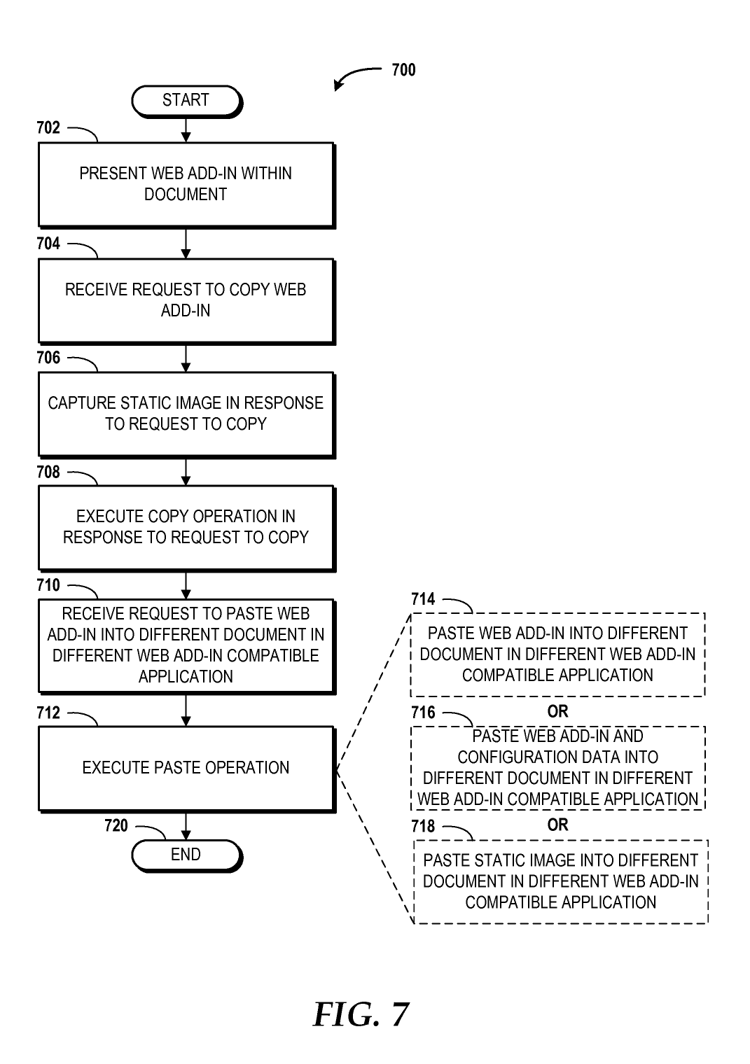

Turning now to FIG. 7, a method 700 for copying and pasting a web add-in will be described, according to an illustrative embodiment. The method 700 is described with additional reference to FIG. 1. In particular, the method 700 is described as being performed by the user computer 102 executing the web add-in compatible application 110 and a different web add-in compatible application.

The method 700 begins and proceeds to operation 702, wherein the user computer 102 presents the web add-in 116 within the document 114. From operation 702, the method 700 proceeds to operation 704, wherein the user computer 102 receives a request to copy the web add-in 116. In response to receiving the request to copy the web add-in 116, the user computer 102, at operation 706, captures a static image of the web add-in 116. Also in response to receiving the request to copy the web add-in 116, the user computer 102, at operation 708, executes a copy operation to copy the web add-in 116. It should be understood that the operations 706, 708 may be performed in parallel or sequentially in any order after receiving the request to copy the web add-in 116.

From operation 708, the method 700 proceeds to operation 710, wherein the user computer 102 receives a request to paste the web add-in 116 into a different document that has been opened using a different web add-in compatible application. At operation 712, the user computer 102 executes a paste operation. In some embodiments, the paste operation includes pasting the web add-in 116 into the different document in the different web add-in compatible application, as illustrated at operation 714. In some other embodiments, the paste operation includes pasting the web add-in 116 and the configuration data 121 into the different document in the different web add-in compatible application, as illustrated at operation 716. In some other embodiments, the paste operation includes pasting the static image captured at operation 706 into the different document in the different web add-in compatible application, as illustrated at operation 718. The method 700 then proceeds to operation 720, wherein the method 700 may end.

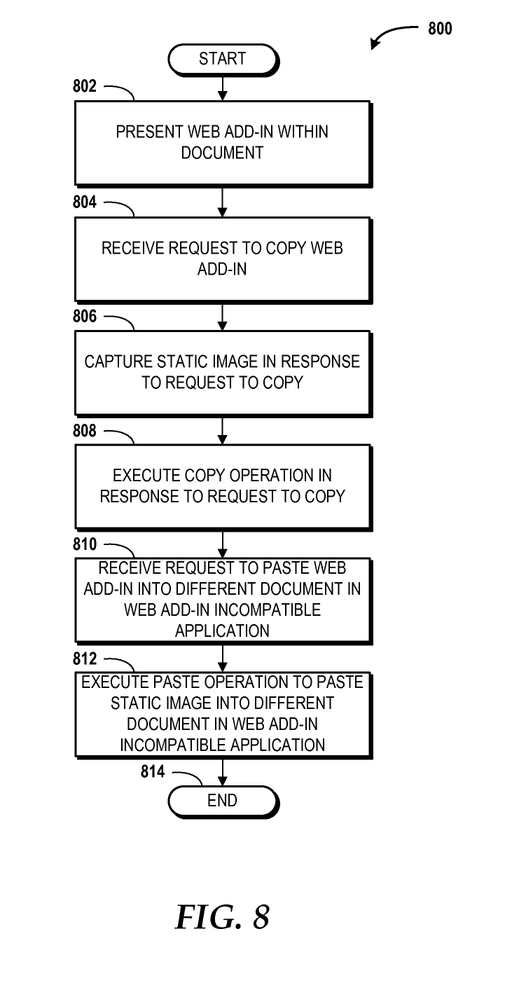

Turning now to FIG. 8, a method 800 for copying and pasting a web add-in will be described, according to an illustrative embodiment. The method 800 is described with additional reference to FIG. 1. In particular, the method 800 is described as being performed by the user computer 102 executing the web add-in compatible application 110 and the web add-in incompatible application 112.

The method 800 begins and proceeds to operation 802, wherein the user computer 102 presents the web add-in 116 within the document 114. From operation 802, the method 800 proceeds to operation 804, wherein the user computer 102 receives a request to copy the web add-in 116. In response to receiving the request to copy the web add-in 116, the user computer 102, at operation 806, captures a static image of the web add-in 116. Also in response to receiving the request to copy the web add-in 116, the user computer 102, at operation 808, executes a copy operation to copy the web add-in 116. It should be understood that the operations 806, 808 may be performed in parallel or sequentially in any order after receiving the request to copy the web add-in 116.

From operation 808, the method 800 proceeds to operation 810, wherein the user computer 102 receives a request to paste the web add-in 116 into a different document that has been opened using the web add-in incompatible application 112. At operation 812, the user computer 102 executes a paste operation to paste the static image captured at operation 806 into the different document in the web add-in incompatible application 112. The method 800 then proceeds to operation 814, wherein the method 800 may end.

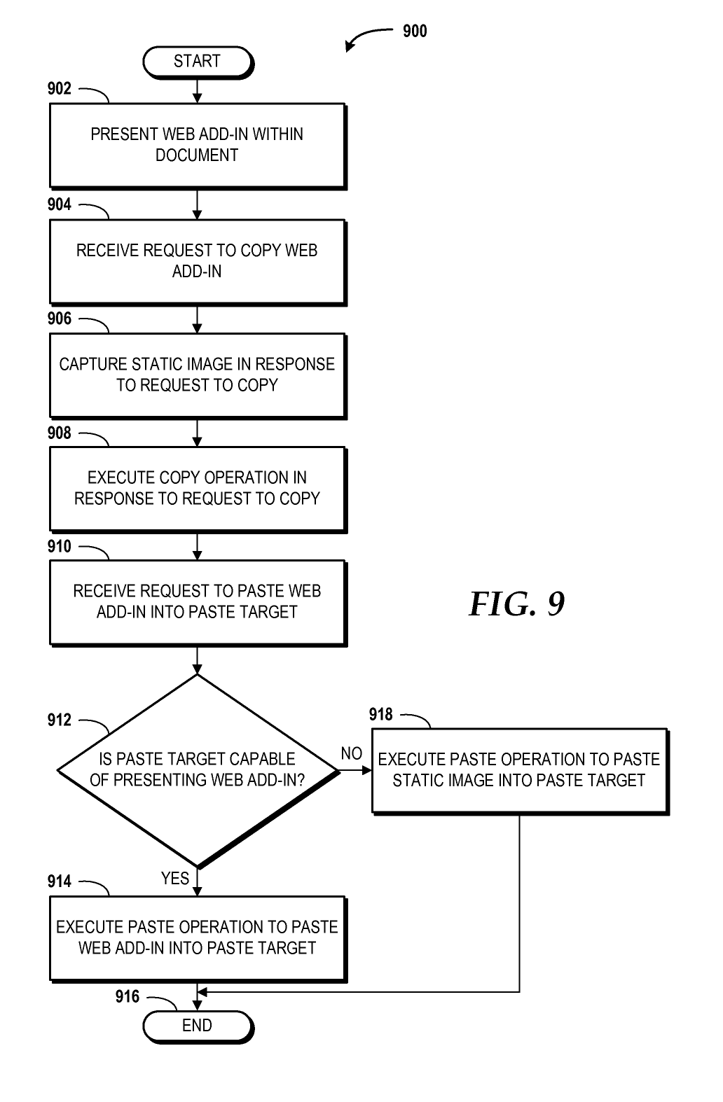

Turning now to FIG. 9, a method 900 for copying and pasting a web add-in will be described, according to an illustrative embodiment. The method 900 is described with additional reference to FIG. 1. In particular, the method 900 is described as being performed by the user computer 102 executing the web add-in compatible application 110 and the web add-in incompatible application 112.

The method 900 begins and proceeds to operation 902, wherein the user computer 102 presents the web add-in 116 within the document 114. From operation 902, the method 900 proceeds to operation 904, wherein the user computer 102 receives a request to copy the web add-in 116. In response to receiving the request to copy the web add-in 116, the user computer 102, at operation 906, captures a static image of the web add-in 116. Also in response to receiving the request to copy the web add-in 116, the user computer 102, at operation 908, executes a copy operation to copy the web add-in 116. It should be understood that the operations 906, 908 may be performed in parallel or sequentially in any order after receiving the request to copy the web add-in 116.

From operation 908, the method 900 proceeds to operation 910, wherein the user computer 102 receives a request to paste the web add-in 116 into a paste target. From operation 910, the method 900 proceeds to operation 912, wherein the user computer 102 determines if the paste target is capable of presenting the web add-in 116.

If the user computer 102 determines, at operation 912, that the paste target is capable of presenting the web add-in 116, such as if the paste target is a new location within the document 114, if the paste target is a different document that has been opened using the web add-in compatible application 110, or if the paste target is a different web add-in compatible application, the method 900 proceeds to operation 914. At operation 914, the user computer 102 executes a paste operation to paste the web add-in 116 into the paste target. The method 900 then proceeds to operation 916, wherein the method 900 may end.

If the user computer 102 determines, at operation 912, that the paste target is incapable of presenting the web add-in 116, such as if the paste target is a different document that has been opened using the web add-in incompatible application 112 or another web add-in incompatible application, the method 900 proceeds to operation 916. At operation 916, the method 900 may end.

A paste target, in some embodiments, is incapable of presenting the web add-in 116 based upon a temporary condition, such as a loss of connectivity to the web add-in server computer 106. In some other embodiments, a paste target is incapable of presenting the web add-in 116 based upon an active mode or view of the web add-in compatible application 110. For example, the web add-in compatible application 110 can be in a read-only mode in which web content would not render properly and so a static image is better suited thereto. As another example, the web add-in compatible application 110 can be in an advanced view in which two or more instances of the web add-in 116 are viewable, but at least one of the instances is not live and so a static image is better suited for that particular instance.

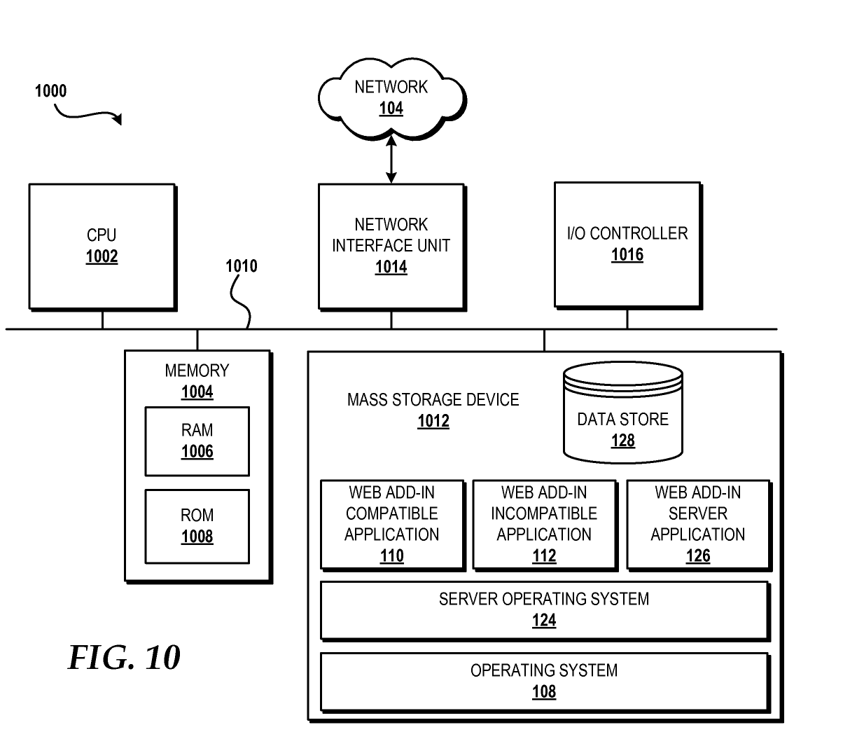

FIG. 10 illustrates an illustrative computer architecture 1000 for a device capable of executing the software components described herein for rendering web content within documents, among other aspects. Thus, the computer architecture 1000 illustrated in FIG. 10 illustrates an architecture for a server computer, mobile phone, a PDA, a smart phone, a desktop computer, a netbook computer, a tablet computer, and/or a laptop computer. The computer architecture 1000 may be utilized to execute any aspects of the software components presented herein.

In some embodiments, the user computer 102 and/or the web add-in server computer are configured in accordance with the computer architecture 1000. As such, software components of the user computer 102 and the web add-in server computer 106 are shown together within the computer architecture 1000 for ease of illustration. It should be understood, however, that these software components may be and are likely to be implemented in separate computers, such as in a client/server configuration, or as standalone software components executing on one or both of the user computer 102 and the web add-in server computer 106.

The computer architecture 1000 illustrated in FIG. 10 includes a central processing unit 1002 (“CPU”), a system memory 1004, including a random access memory 1006 (“RAM”) and a read-only memory (“ROM”) 1008, and a system bus 1010 that couples the memory 1004 to the CPU 1002. A basic input/output system containing the basic routines that help to transfer information between elements within the computer architecture 1000, such as during startup, is stored in the ROM 1008. The computer architecture 1000 further includes a mass storage device 1012 for storing the operating system 108, the server operating system 124, and one or more application programs including, but not limited to, the web add-in compatible application 110, the web add-in incompatible application 112, and the web add-in server application 126. In the illustrated embodiment, the mass storage device 1012 also stores the data store 128.

The mass storage device 1012 is connected to the CPU 1002 through a mass storage controller (not shown) connected to the bus 1010. The mass storage device 1012 and its associated computer-readable media provide non-volatile storage for the computer architecture 1000. Although the description of computer-readable media contained herein refers to a mass storage device, such as a hard disk or CD-ROM drive, it should be appreciated by those skilled in the art that computer-readable media can be any available computer storage media or communication media that can be accessed by the computer architecture 1000.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, but not limitation, communication media includes wired media such as a wired network or direct-wired connection, and wireless media such as acoustic, RF, infrared and other wireless media. Combinations of the any of the above should also be included within the scope of computer-readable media.

By way of example, but not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 1000. For purposes the claims, the phrase “computer storage medium” and variations thereof, does not include waves, signals, and/or other transitory and/or intangible communication media, per se.

According to various embodiments, the computer architecture 1000 may operate in a networked environment using logical connections to remote computers through the network 104 and/or another network (not shown). The computer architecture 1000 may connect to the network 104 through a network interface unit 1014 connected to the bus 1010. It should be appreciated that the network interface unit 1014 also may be utilized to connect to other types of networks and remote computer systems. The computer architecture 1000 also may include an input/output controller 1016 for receiving and processing input from a number of other devices, including a keyboard, mouse, or electronic stylus (not shown in FIG. 10). Similarly, the input/output controller 1016 may provide output to a display screen, a printer, or other type of output device (also not shown in FIG. 10).

It should be appreciated that the software components described herein may, when loaded into the CPU 1002 and executed, transform the CPU 1002 and the overall computer architecture 1000 from a general-purpose computing system into a special-purpose computing system customized to facilitate the functionality presented herein. The CPU 1002 may be constructed from any number of transistors or other discrete circuit elements, which may individually or collectively assume any number of states. More specifically, the CPU 1002 may operate as a finite-state machine, in response to executable instructions contained within the software modules disclosed herein. These computer-executable instructions may transform the CPU 1002 by specifying how the CPU 1002 transitions between states, thereby transforming the transistors or other discrete hardware elements constituting the CPU 1002.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 1000 in order to store and execute the software components presented herein. It also should be appreciated that the computer architecture 1000 may include other types of computing devices, including hand-held computers, embedded computer systems, personal digital assistants, and other types of computing devices known to those skilled in the art. It is also contemplated that the computer architecture 1000 may not include all of the components shown in FIG. 10, may include other components that are not explicitly shown in FIG. 10, or may utilize an architecture completely different than that shown in FIG. 10.

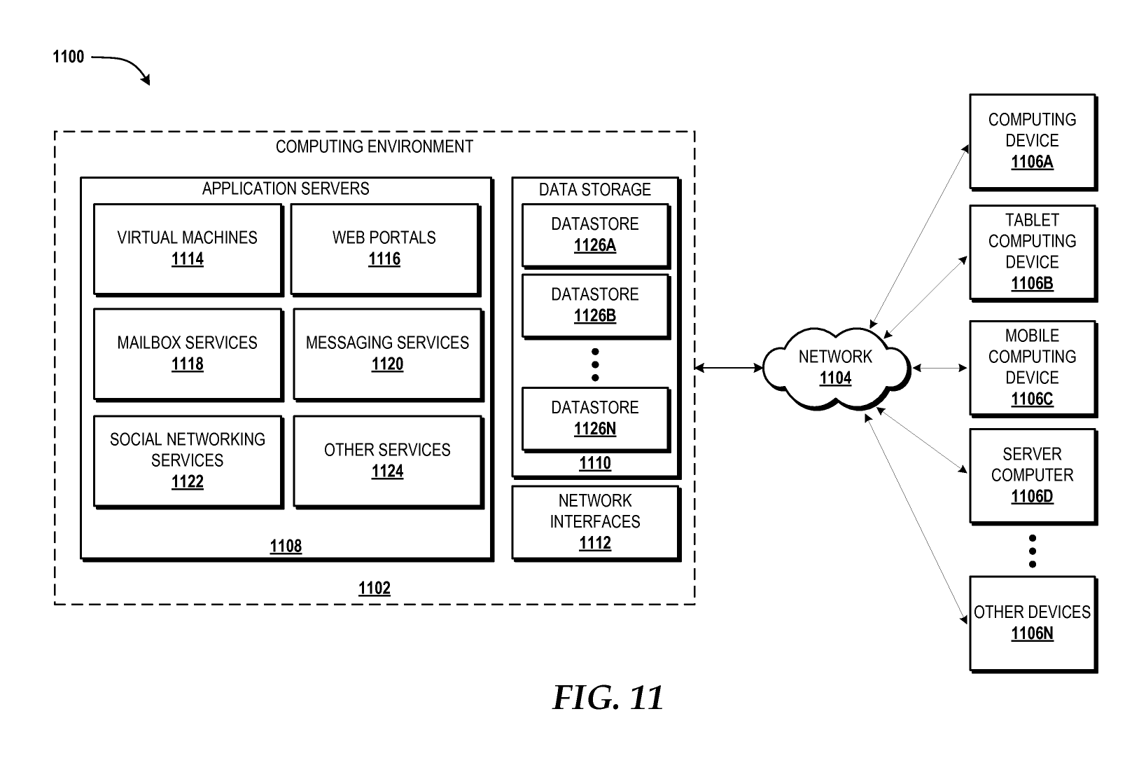

FIG. 11 illustrates an illustrative distributed computing environment 1100 capable of executing the software components described herein for rendering web content in documents, among other aspects. Thus, the distributed computing environment 1100 illustrated in FIG. 11 can be utilized to execute any aspects of the software components presented herein. For example, the distributed computing environment 1100 can be utilized to execute aspects of the web add-in server application 126 and/or other software components described herein.

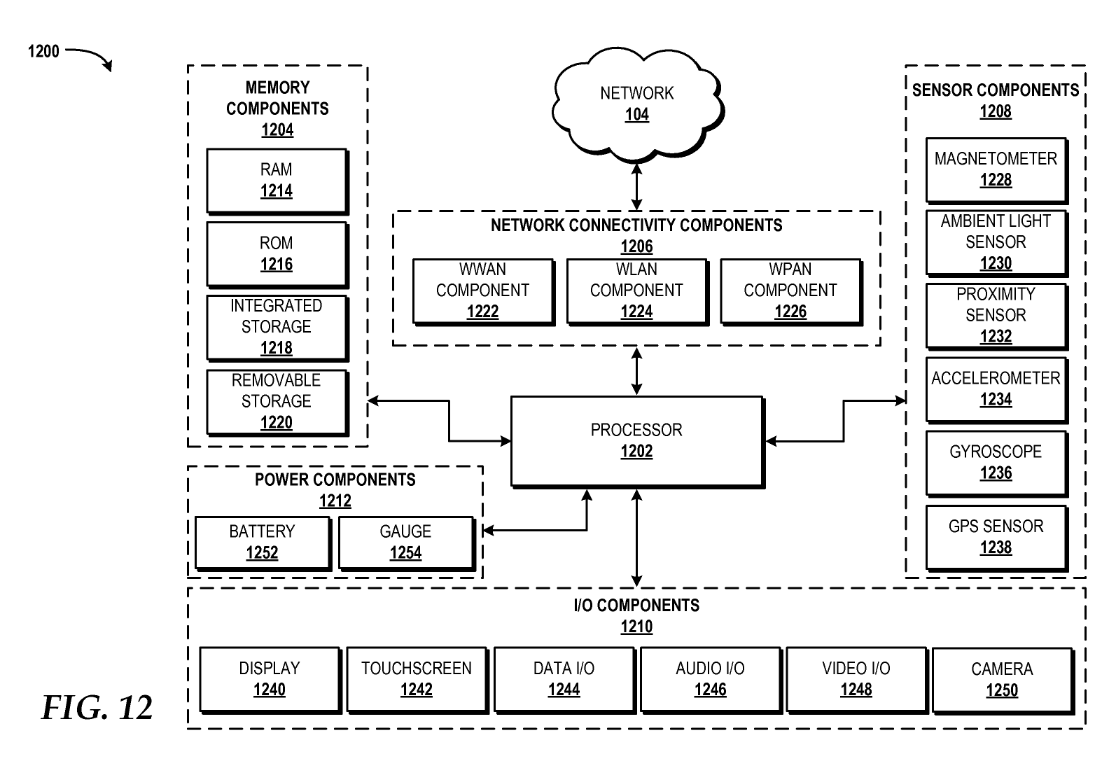

According to various implementations, the distributed computing environment 1100 includes a computing environment 1102 operating on, in communication with, or as part of the network 1104. The network 1104 may be or may include the network 104, described above with reference to FIG. 1. The network 1104 also can include various access networks. One or more client devices 1106A-1106N (hereinafter referred to collectively and/or generically as “clients 1106”) can communicate with the computing environment 1102 via the network 1104 and/or other connections (not illustrated in FIG. 11). In the illustrated embodiment, the clients 1106 include a computing device 1106A such as a laptop computer, a desktop computer, or other computing device; a slate or tablet computing device (“tablet computing device”) 1106B; a mobile computing device 1106C such as a mobile telephone, a smart phone, or other mobile computing device; a server computer 1106D; and/or other devices 1106N. It should be understood that any number of clients 1106 can communicate with the computing environment 1102. Two example computing architectures for the clients 1106 are illustrated and described herein with reference to FIGS. 10 and 12. The clients 1106 may include the user computer 102. It should be understood that the illustrated clients 1106 and computing architectures illustrated and described herein are illustrative, and should not be construed as being limited in any way.

In the illustrated embodiment, the computing environment 1102 includes application servers 1108, data storage 1110, and one or more network interfaces 1112. According to various implementations, the functionality of the application servers 1108 can be provided by one or more server computers that are executing as part of, or in communication with, the network 1104. The application servers 1108 can host various services, virtual machines, portals, and/or other resources. In the illustrated embodiment, the application servers 1108 host one or more virtual machines 1114 for hosting applications or other functionality. According to various implementations, the virtual machines 1114 host one or more applications and/or software modules for providing the functionality described herein for rendering web content within documents, among other aspects. It should be understood that this embodiment is illustrative, and should not be construed as being limiting in any way. The application servers 1108 also host or provide access to one or more Web portals, link pages, Web sites, and/or other information (“Web portals”) 1116.

According to various implementations, the application servers 1108 also include one or more mailbox services 1118 and one or more messaging services 1120. The mailbox services 1118 can include electronic mail (“email”) services. The mailbox services 1118 also can include various personal information management (“PIM”) services including, but not limited to, calendar services, contact management services, collaboration services, and/or other services. The messaging services 1120 can include, but are not limited to, instant messaging services, chat services, forum services, and/or other communication services.

The application servers 1108 also can include one or more social networking services 1122. The social networking services 1122 can include various social networking services including, but not limited to, services for sharing or posting status updates, instant messages, links, photos, videos, and/or other information; services for commenting or displaying interest in articles, products, blogs, or other resources; and/or other services. In some embodiments, the social networking services 1122 are provided by or include the FACEBOOK social networking service, the LINKEDIN professional networking service, the MYSPACE social networking service, the FOURSQUARE geographic networking service, the YAMMER office colleague networking service, and the like. In other embodiments, the social networking services 1122 are provided by other services, sites, and/or providers that may or may not be explicitly known as social networking providers. For example, some web sites allow users to interact with one another via email, chat services, and/or other means during various activities and/or contexts such as reading published articles, commenting on goods or services, publishing, collaboration, gaming, and the like. Examples of such services include, but are not limited to, the WINDOWS LIVE service and the XBOX LIVE service from Microsoft Corporation in Redmond, Wash. Other services are possible and are contemplated.

The social networking services 1122 also can include commenting, blogging, and/or micro blogging services. Examples of such services include, but are not limited to, the YELP commenting service, the KUDZU review service, the OFFICETALK enterprise micro blogging service, the TWITTER messaging service, the GOOGLE+ service, and/or other services. It should be appreciated that the above lists of services are not exhaustive and that numerous additional and/or alternative social networking services 1122 are not mentioned herein for the sake of brevity. As such, the above embodiments are illustrative, and should not be construed as being limited in any way.

As shown in FIG. 11, the application servers 1108 also can host other services, applications, portals, and/or other resources (“other resources”) 1124. The other resources 1124 can include, but are not limited to, the presentation application program. It thus can be appreciated that the computing environment 1102 can provide integration of the concepts and technologies disclosed herein provided herein with various mailbox, messaging, social networking, and/or other services or resources.

As mentioned above, the computing environment 1102 can include the data storage 1110. According to various implementations, the functionality of the data storage 1110 is provided by one or more databases operating on, or in communication with, the network 1104. The functionality of the data storage 1110 also can be provided by one or more server computers configured to host data for the computing environment 1102. The data storage 1110 can include, host, or provide one or more real or virtual datastores 1126A-1126N (hereinafter referred to collectively and/or generically as “datastores 1126”). The datastores 1126 are configured to host data used or created by the application servers 1108 and/or other data. Although not illustrated in FIG. 11, the datastores 1126 also can host or store web add-ins, documents, web content, and/or the like.

The computing environment 1102 can communicate with, or be accessed by, the network interfaces 1112. The network interfaces 1112 can include various types of network hardware and software for supporting communications between two or more computing devices including, but not limited to, the clients 1106 and the application servers 1108. It should be appreciated that the network interfaces 1112 also may be utilized to connect to other types of networks and/or computer systems.

It should be understood that the distributed computing environment 1100 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 1100 provides the software functionality described herein as a service to the clients 1106. It should be understood that the clients 1106 can include real or virtual machines including, but not limited to, server computers, web servers, personal computers, mobile computing devices, smart phones, and/or other devices. As such, various embodiments of the concepts and technologies disclosed herein enable any device configured to access the distributed computing environment 1100 to utilize the functionality described herein for rendering web content within documents, among other aspects.

Turning now to FIG. 12, an illustrative computing device architecture 1200 for a computing device that is capable of executing various software components described herein for rendering web content within documents, among other aspects. In some embodiments, the user computer 106 and/or the marketplace server computer 106 uses the architecture 1200 or some variation thereof. The computing device architecture 1200 is applicable to computing devices that facilitate mobile computing due, in part, to form factor, wireless connectivity, and/or battery-powered operation. In some embodiments, the computing devices include, but are not limited to, mobile telephones, tablet devices, slate devices, portable video game devices, and the like. The computing device architecture 1200 is applicable to any of the clients 1106 shown in FIG. 11. Moreover, aspects of the computing device architecture 1200 may be applicable to traditional desktop computers, portable computers (e.g., laptops, notebooks, ultra-portables, and netbooks), server computers, and other computer systems, such as described herein with reference to FIG. 10. For example, the single touch and multi-touch aspects disclosed herein below may be applied to desktop computers that utilize a touchscreen or some other touch-enabled device, such as a touch-enabled track pad or touch-enabled mouse.

The computing device architecture 1200 illustrated in FIG. 12 includes a processor 1202, memory components 1204, network connectivity components 1206, sensor components 1208, input/output components 1210, and power components 1212. In the illustrated embodiment, the processor 1202 is in communication with the memory components 1204, the network connectivity components 1206, the sensor components 1208, the input/output (“I/O”) components 1210, and the power components 1212. Although no connections are shown between the individuals components illustrated in FIG. 12, the components can interact to carry out device functions. In some embodiments, the components are arranged so as to communicate via one or more busses (not shown).

The processor 1202 includes a central processing unit (“CPU”) configured to process data, execute computer-executable instructions of one or more application programs, and communicate with other components of the computing device architecture 1200 in order to perform various functionality described herein. The processor 1202 may be utilized to execute aspects of the software components presented herein and, particularly, those that utilize, at least in part, a touch-enabled input.

In some embodiments, the processor 1202 includes a graphics processing unit (“GPU”) configured to accelerate operations performed by the CPU, including, but not limited to, operations performed by executing general-purpose scientific and/or engineering computing applications, as well as graphics-intensive computing applications such as high resolution video (e.g., 720P, 1080P, and higher resolution), video games, three-dimensional (“3D”) modeling applications, and the like. In some embodiments, the processor 1202 is configured to communicate with a discrete GPU (not shown). In any case, the CPU and GPU may be configured in accordance with a co-processing CPU/GPU computing model, wherein the sequential part of an application executes on the CPU and the computationally-intensive part is accelerated by the GPU.

In some embodiments, the processor 1202 is, or is included in, a system-on-chip (“SoC”) along with one or more of the other components described herein below. For example, the SoC may include the processor 1202, a GPU, one or more of the network connectivity components 1206, and one or more of the sensor components 1208. In some embodiments, the processor 1202 is fabricated, in part, utilizing a package-on-package (“PoP”) integrated circuit packaging technique. The processor 1202 may be a single core or multi-core processor.

The processor 1202 may be created in accordance with an ARM architecture, available for license from ARM HOLDINGS of Cambridge, United Kingdom. Alternatively, the processor 1202 may be created in accordance with an x86 architecture, such as is available from INTEL CORPORATION of Mountain View, Calif. and others. In some embodiments, the processor 1202 is a SNAPDRAGON SoC, available from QUALCOMM of San Diego, Calif.; a TEGRA SoC, available from NVIDIA of Santa Clara, Calif.; a HUMMINGBIRD SoC, available from SAMSUNG of Seoul, South Korea; an Open Multimedia Application Platform (“OMAP”) SoC, available from TEXAS INSTRUMENTS of Dallas, Tex.; a customized version of any of the above SoCs; or a proprietary SoC.

The memory components 1204 include a random access memory (“RAM”) 1214, a read-only memory (“ROM”) 1216, an integrated storage memory (“integrated storage”) 1218, and a removable storage memory (“removable storage”) 1220. In some embodiments, the RAM 1214 or a portion thereof, the ROM 1216 or a portion thereof, and/or some combination the RAM 1214 and the ROM 1216 is integrated in the processor 1202. In some embodiments, the ROM 1216 is configured to store a firmware, an operating system or a portion thereof (e.g., operating system kernel), and/or a bootloader to load an operating system kernel from the integrated storage 1218 and/or the removable storage 1220.

The integrated storage 1218 can include a solid-state memory, a hard disk, or a combination of solid-state memory and a hard disk. The integrated storage 1218 may be soldered or otherwise connected to a logic board upon which the processor 1202 and other components described herein also may be connected. As such, the integrated storage 1218 is integrated in the computing device. The integrated storage 1218 is configured to store an operating system or portions thereof, application programs, data, and other software components described herein.

The removable storage 1220 can include a solid-state memory, a hard disk, or a combination of solid-state memory and a hard disk. In some embodiments, the removable storage 1220 is provided in lieu of the integrated storage 1218. In other embodiments, the removable storage 1220 is provided as additional optional storage. In some embodiments, the removable storage 1220 is logically combined with the integrated storage 1218 such that the total available storage is made available as a total combined storage capacity. In some embodiments, the total combined capacity of the integrated storage 1218 and the removable storage 1220 is shown to a user instead of separate storage capacities for the integrated storage 1218 and the removable storage 1220.

The removable storage 1220 is configured to be inserted into a removable storage memory slot (not shown) or other mechanism by which the removable storage 1220 is inserted and secured to facilitate a connection over which the removable storage 1220 can communicate with other components of the computing device, such as the processor 1202. The removable storage 1220 may be embodied in various memory card formats including, but not limited to, PC card, CompactFlash card, memory stick, secure digital (“SD”), miniSD, microSD, universal integrated circuit card (“UICC”) (e.g., a subscriber identity module (“SIM”) or universal SIM (“USIM”)), a proprietary format, or the like.

It can be understood that one or more of the memory components 1204 can store an operating system. According to various embodiments, the operating system includes, but is not limited to, SYMBIAN OS from SYMBIAN LIMITED, WINDOWS mobile OS from Microsoft Corporation of Redmond, Wash., WINDOWS phone OS from Microsoft Corporation, WINDOWS from Microsoft Corporation, PALM WEBOS from Hewlett-Packard Company of Palo Alto, Calif., BLACKBERRY OS from Research In Motion Limited of Waterloo, Ontario, Canada, IOS from Apple Inc. of Cupertino, Calif., and ANDROID OS from Google Inc. of Mountain View, Calif. Other operating systems are contemplated.

The network connectivity components 1206 include a wireless wide area network component (“WWAN component”) 1222, a wireless local area network component (“WLAN component”) 1224, and a wireless personal area network component (“WPAN component”) 1226. The network connectivity components 1206 facilitate communications to and from the network 104 or another network, which may be a WWAN, a WLAN, or a WPAN. Although only the network 104 is illustrated, the network connectivity components 1206 may facilitate simultaneous communication with multiple networks. For example, the network connectivity components 1206 may facilitate simultaneous communications with multiple networks via one or more of a WWAN, a WLAN, or a WPAN.

The network 104 may be or may include a WWAN, such as a mobile telecommunications network utilizing one or more mobile telecommunications technologies to provide voice and/or data services to a computing device utilizing the computing device architecture 1200 via the WWAN component 1222. The mobile telecommunications technologies can include, but are not limited to, Global System for Mobile communications (“GSM”), Code Division Multiple Access (“CDMA”) ONE, CDMA2000, Universal Mobile Telecommunications System (“UMTS”), Long Term Evolution (“LTE”), and Worldwide Interoperability for Microwave Access (“WiMAX”). Moreover, the network 104 may utilize various channel access methods (which may or may not be used by the aforementioned standards) including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Space Division Multiple Access (“SDMA”), and the like. Data communications may be provided using General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and various other current and future wireless data access standards. The network 104 may be configured to provide voice and/or data communications with any combination of the above technologies. The network 104 may be configured to or adapted to provide voice and/or data communications in accordance with future generation technologies.

In some embodiments, the WWAN component 1222 is configured to provide dual-multi-mode connectivity to the network 104. For example, the WWAN component 1222 may be configured to provide connectivity to the network 104, wherein the network 104 provides service via GSM and UMTS technologies, or via some other combination of technologies. Alternatively, multiple WWAN components 1222 may be utilized to perform such functionality, and/or provide additional functionality to support other non-compatible technologies (i.e., incapable of being supported by a single WWAN component). The WWAN component 1222 may facilitate similar connectivity to multiple networks (e.g., a UMTS network and an LTE network).

The network 104 may be a WLAN operating in accordance with one or more Institute of Electrical and Electronic Engineers (“IEEE”) 802.11 standards, such as IEEE 802.11a, 802.11b, 802.11g, 802.11n, and/or future 802.11 standard (referred to herein collectively as WI-FI). Draft 802.11 standards are also contemplated. In some embodiments, the WLAN is implemented utilizing one or more wireless WI-FI access points. In some embodiments, one or more of the wireless WI-FI access points are another computing device with connectivity to a WWAN that are functioning as a WI-FI hotspot. The WLAN component 1224 is configured to connect to the network 104 via the WI-FI access points. Such connections may be secured via various encryption technologies including, but not limited, WI-FI Protected Access (“WPA”), WPA2, Wired Equivalent Privacy (“WEP”), and the like.

The network 104 may be a WPAN operating in accordance with Infrared Data Association (“IrDA”), BLUETOOTH, wireless Universal Serial Bus (“USB”), Z-Wave, ZIGBEE, or some other short-range wireless technology. In some embodiments, the WPAN component 1226 is configured to facilitate communications with other devices, such as peripherals, computers, or other computing devices via the WPAN.

The sensor components 1208 include a magnetometer 1228, an ambient light sensor 1230, a proximity sensor 1232, an accelerometer 1234, a gyroscope 1236, and a Global Positioning System sensor (“GPS sensor”) 1238. It is contemplated that other sensors, such as, but not limited to, temperature sensors or shock detection sensors, also may be incorporated in the computing device architecture 1200.

The magnetometer 1228 is configured to measure the strength and direction of a magnetic field. In some embodiments the magnetometer 1228 provides measurements to a compass application program stored within one of the memory components 1204 in order to provide a user with accurate directions in a frame of reference including the cardinal directions, north, south, east, and west. Similar measurements may be provided to a navigation application program that includes a compass component. Other uses of measurements obtained by the magnetometer 1228 are contemplated.

The ambient light sensor 1230 is configured to measure ambient light. In some embodiments, the ambient light sensor 1230 provides measurements to an application program stored within one the memory components 1204 in order to automatically adjust the brightness of a display (described below) to compensate for low-light and high-light environments. Other uses of measurements obtained by the ambient light sensor 1230 are contemplated.

The proximity sensor 1232 is configured to detect the presence of an object or thing in proximity to the computing device without direct contact. In some embodiments, the proximity sensor 1232 detects the presence of a user's body (e.g., the user's face) and provides this information to an application program stored within one of the memory components 1204 that utilizes the proximity information to enable or disable some functionality of the computing device. For example, a telephone application program may automatically disable a touchscreen (described below) in response to receiving the proximity information so that the user's face does not inadvertently end a call or enable/disable other functionality within the telephone application program during the call. Other uses of proximity as detected by the proximity sensor 1232 are contemplated.

The accelerometer 1234 is configured to measure proper acceleration. In some embodiments, output from the accelerometer 1234 is used by an application program as an input mechanism to control some functionality of the application program. For example, the application program may be a video game in which a character, a portion thereof, or an object is moved or otherwise manipulated in response to input received via the accelerometer 1234. In some embodiments, output from the accelerometer 1234 is provided to an application program for use in switching between landscape and portrait modes, calculating coordinate acceleration, or detecting a fall. Other uses of the accelerometer 1234 are contemplated.

The gyroscope 1236 is configured to measure and maintain orientation. In some embodiments, output from the gyroscope 1236 is used by an application program as an input mechanism to control some functionality of the application program. For example, the gyroscope 1236 can be used for accurate recognition of movement within a 3D environment of a video game application or some other application. In some embodiments, an application program utilizes output from the gyroscope 1236 and the accelerometer 1234 to enhance control of some functionality of the application program. Other uses of the gyroscope 1236 are contemplated.

The GPS sensor 1238 is configured to receive signals from GPS satellites for use in calculating a location. The location calculated by the GPS sensor 1238 may be used by any application program that requires or benefits from location information. For example, the location calculated by the GPS sensor 1238 may be used with a navigation application program to provide directions from the location to a destination or directions from the destination to the location. Moreover, the GPS sensor 1238 may be used to provide location information to an external location-based service, such as E911 service. The GPS sensor 1238 may obtain location information generated via WI-FI, WIMAX, and/or cellular triangulation techniques utilizing one or more of the network connectivity components 1206 to aid the GPS sensor 1238 in obtaining a location fix. The GPS sensor 1238 may also be used in Assisted GPS (“A-GPS”) systems.

The I/O components 1210 include a display 1240, a touchscreen 1242, a data I/O interface component (“data I/O”) 1244, an audio I/O interface component (“audio I/O”) 1246, a video I/O interface component (“video I/O”) 1248, and a camera 1250. In some embodiments, the display 1240 and the touchscreen 1242 are combined. In some embodiments two or more of the data I/O component 1244, the audio I/O component 1246, and the video I/O component 1248 are combined. The I/O components 1210 may include discrete processors configured to support the various interface described below, or may include processing functionality built-in to the processor 1202.

The display 1240 is an output device configured to present information in a visual form. In particular, the display 1240 may present GUI elements, web add-in interfaces, text, images, video, notifications, virtual buttons, virtual keyboards, messaging data, Internet content, device status, time, date, calendar data, preferences, map information, location information, and any other information that is capable of being presented in a visual form. In some embodiments, the display 1240 is a liquid crystal display (“LCD”) utilizing any active or passive matrix technology and any backlighting technology (if used). In some embodiments, the display 1240 is an organic light emitting diode (“OLED”) display. Other display types are contemplated.

The touchscreen 1242 is an input device configured to detect the presence and location of a touch. The touchscreen 1242 may be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or may utilize any other touchscreen technology. In some embodiments, the touchscreen 1242 is incorporated on top of the display 1240 as a transparent layer to enable a user to use one or more touches to interact with objects or other information presented on the display 1240. In other embodiments, the touchscreen 1242 is a touch pad incorporated on a surface of the computing device that does not include the display 1240. For example, the computing device may have a touchscreen incorporated on top of the display 1240 and a touch pad on a surface opposite the display 1240.

In some embodiments, the touchscreen 1242 is a single-touch touchscreen. In other embodiments, the touchscreen 1242 is a multi-touch touchscreen. In some embodiments, the touchscreen 1242 is configured to detect discrete touches, single touch gestures, and/or multi-touch gestures. These are collectively referred to herein as gestures for convenience. Several gestures will now be described. It should be understood that these gestures are illustrative and are not intended to limit the scope of the appended claims. Moreover, the described gestures, additional gestures, and/or alternative gestures may be implemented in software for use with the touchscreen 1242. As such, a developer may create gestures that are specific to a particular application program and/or to a specific web add-in.

In some embodiments, the touchscreen 1242 supports a tap gesture in which a user taps the touchscreen 1242 once on an item presented on the display 1240. The tap gesture may be used for various reasons including, but not limited to, opening or launching whatever the user taps. In some embodiments, the touchscreen 1242 supports a double tap gesture in which a user taps the touchscreen 1242 twice on an item presented on the display 1240. The double tap gesture may be used for various reasons including, but not limited to, zooming in or zooming out in stages. In some embodiments, the touchscreen 1242 supports a tap and hold gesture in which a user taps the touchscreen 1242 and maintains contact for at least a pre-defined time. The tap and hold gesture may be used for various reasons including, but not limited to, opening a context-specific menu.

In some embodiments, the touchscreen 1242 supports a pan gesture in which a user places a finger on the touchscreen 1242 and maintains contact with the touchscreen 1242 while moving the finger on the touchscreen 1242. The pan gesture may be used for various reasons including, but not limited to, moving through screens, images, or menus at a controlled rate. Multiple finger pan gestures are also contemplated. In some embodiments, the touchscreen 1242 supports a flick gesture in which a user swipes a finger in the direction the user wants the screen to move. The flick gesture may be used for various reasons including, but not limited to, scrolling horizontally or vertically through menus or pages. In some embodiments, the touchscreen 1242 supports a pinch and stretch gesture in which a user makes a pinching motion with two fingers (e.g., thumb and forefinger) on the touchscreen 1242 or moves the two fingers apart. The pinch and stretch gesture may be used for various reasons including, but not limited to, zooming gradually in or out of a website, map, picture, or web add-in.

Although the above gestures have been described with reference to the use one or more fingers for performing the gestures, other appendages such as toes or objects such as styluses may be used to interact with the touchscreen 1242. As such, the above gestures should be understood as being illustrative and should not be construed as being limiting in any way.

The data I/O interface component 1244 is configured to facilitate input of data to the computing device and output of data from the computing device. In some embodiments, the data I/O interface component 1244 includes a connector configured to provide wired connectivity between the computing device and a computer system, for example, for synchronization operation purposes. The connector may be a proprietary connector or a standardized connector such as USB, micro-USB, mini-USB, or the like. In some embodiments, the connector is a dock connector for docking the computing device with another device such as a docking station, audio device (e.g., a digital music player), or video device.

The audio I/O interface component 1246 is configured to provide audio input and/or output capabilities to the computing device. In some embodiments, the audio I/O interface component 1244 includes a microphone configured to collect audio signals. In some embodiments, the audio I/O interface component 1244 includes a headphone jack configured to provide connectivity for headphones or other external speakers. In some embodiments, the audio I/O interface component 1246 includes a speaker for the output of audio signals. In some embodiments, the audio I/O interface component 1244 includes an optical audio cable out.

The video I/O interface component 1248 is configured to provide video input and/or output capabilities to the computing device. In some embodiments, the video I/O interface component 1248 includes a video connector configured to receive video as input from another device (e.g., a video media player such as a DVD or BLURAY player) or send video as output to another device (e.g., a monitor, a television, or some other external display). In some embodiments, the video I/O interface component 1248 includes a High-Definition Multimedia Interface (“HDMI”), mini-HDMI, micro-HDMI, DisplayPort, or proprietary connector to input/output video content. In some embodiments, the video I/O interface component 1248 or portions thereof is combined with the audio I/O interface component 1246 or portions thereof.

The camera 1250 can be configured to capture still images and/or video. The camera 1250 may utilize a charge coupled device (“CCD”) or a complementary metal oxide semiconductor (“CMOS”) image sensor to capture images. In some embodiments, the camera 1250 includes a flash to aid in taking pictures in low-light environments. Settings for the camera 1250 may be implemented as hardware or software buttons.

Although not illustrated, one or more hardware buttons may also be included in the computing device architecture 1200. The hardware buttons may be used for controlling some operational aspect of the computing device. The hardware buttons may be dedicated buttons or multi-use buttons. The hardware buttons may be mechanical or sensor-based.

The illustrated power components 1212 include one or more batteries 1252, which can be connected to a battery gauge 1254. The batteries 1252 may be rechargeable or disposable. Rechargeable battery types include, but are not limited to, lithium polymer, lithium ion, nickel cadmium, and nickel metal hydride. Each of the batteries 1252 may be made of one or more cells.

The battery gauge 1254 can be configured to measure battery parameters such as current, voltage, and temperature. In some embodiments, the battery gauge 1254 is configured to measure the effect of a battery's discharge rate, temperature, age and other factors to predict remaining life within a certain percentage of error. In some embodiments, the battery gauge 1254 provides measurements to an application program that is configured to utilize the measurements to present useful power management data to a user. Power management data may include one or more of a percentage of battery used, a percentage of battery remaining, a battery condition, a remaining time, a remaining capacity (e.g., in watt hours), a current draw, and a voltage.

The power components 1212 may also include a power connector, which may be combined with one or more of the aforementioned I/O components 1210. The power components 1212 may interface with an external power system or charging equipment via a power I/O component 1242.

Based on the foregoing, it should be appreciated that technologies for rendering web content within documents have been disclosed herein. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

We claim:

1. A computer-implemented method comprising performing computer-implemented operations for:
presenting, by a computer executing an application, a web add-in within a document, the web add-in comprising a container in which to provide web content within the document;
receiving, by the computer, an input; and
in response to the input, capturing, by the computer, a static image that is representative of the web content at a time instance after the input.

2. The computer-implemented method of claim 1, further comprising presenting the static image in the document in place of the web content.

3. The computer-implemented method of claim 1, further comprising providing the static image behind the web content such that the static image is not visible to a user of the application.

4. The computer-implemented method of claim 1, further comprising:
receiving a request to switch between the web content and the static image; and
in response to the request, switching between the web content and the static image in the document.

5. The computer-implemented method of claim 1, wherein receiving the input comprises receiving a request to save the document.

6. The computer-implemented method of claim 1, wherein receiving the input comprises receiving a request to print the document to a printer device.

7. The computer-implemented method of claim 1, wherein receiving the input comprises receiving a request to print the document to a file.

8. The computer-implemented method of claim 1, wherein receiving the input comprises receiving a request to enter a print preview mode of the application.

9. The computer-implemented method of claim 1, wherein receiving the input comprises receiving a request to enter an advanced view of the application, the advanced view providing two or more instances of the web add-in.

10. The computer-implemented method of claim 1, wherein receiving the input comprises receiving a request to enter a read-only mode of the application.

11. The computer-implemented method of claim 1, wherein receiving the input comprises receiving a notification that a data connection through which the web content is received is no longer available.

12. The computer-implemented method of claim 1, wherein receiving the input comprises receiving a request to cut the web add-in from the document or receiving a request to copy the web add-in from the document.

13. The computer-implemented method of claim 12, further comprising pasting the web add-in into a new location within the document or pasting the web add-in into a different document, wherein the different document is opened in the application or in a different application that is capable of presenting the web add-in.

14. A computer-readable storage medium having computer-executable instructions associated with an application stored thereon that, when executed by a computer, cause the computer to:
present a web add-in within a document, the web add-in comprising a container in which to provide web content within the document;
receive a request to copy the web add-in; and
in response to the request, execute a copy operation.

15. The computer-readable storage medium of claim 14, further having instructions stored thereon that, when executed by the computer, cause the computer to:
receive a request to paste the web add-in into a new location within the document; and
in response to the request to paste the web add-in into the new location, execute a paste operation, the paste operation comprising
pasting the web add-in into the new location,
pasting the web add-in and configuration data of the web add-in into the new location, or
pasting a static image captured in response to the request to copy the web add-in into the new location, the static image being representative of the web content at a time instance after receiving the request to copy the web add-in.

16. The computer-readable storage medium of claim 14, further having instructions stored thereon that, when executed by the computer, cause the computer to:
receive a request to paste the web add-in into a different document that has been opened using the application; and
in response to the request to paste the web add-in into the different document, execute a paste operation, the paste operation comprising
pasting the web add-in into the different document;
pasting the web add-in and configuration data of the web add-in into the different document; or
pasting a static image captured in response to the request to copy the web add-in into the different document, the static image being representative of the web content at a time instance after receiving the request to copy the web add-in.

17. The computer-readable storage medium of claim 14, further having instructions stored thereon that, when executed by the computer, cause the computer to:
receive a request to paste the web add-in into a different document that has been opened using a different application, the different application being capable of presenting the web add-in; and
in response to the request to paste the web add-in into the different document, execute a paste operation, the paste operation comprising
pasting the web add-in into the different document in the different application;
pasting the web add-in and configuration data of the web add-in into the different document in the different application; or
pasting a static image captured in response to the request to copy the web add-in into the different document in the different application, the static image being representative of the web content at a time instance after receiving the request to copy the web add-in.

18. The computer-readable storage medium of claim 14, further having instructions stored thereon that, when executed by the computer, cause the computer to:
receive a request to paste the web add-in into a different document that has been opened using a different application, the different application incapable of presenting the web add-in; and
in response to the request to paste the web add-in into the different document, execute a paste operation, the paste operation comprising pasting a static image captured in response to the request to copy the web add-in into the different document in the different application, the static image being representative of the web content at a time instance after receiving the request to copy the web add-in.

19. A computer-readable storage medium having computer-executable instructions associated with an application stored thereon that, when executed by a computer, cause the computer to:
present a web add-in within a document, the web add-in comprising a container in which to provide web content within the document;
receive a request to copy the web add-in;
in response to the request to copy the web add-in,
execute a capture operation to capture a static image of the web content, the static image being representative of the web content after receiving the request to copy the web add-in, and
execute a copy operation to copy the web add-in;
receive a request to paste the web add-in to a paste target; and
in response to the request to paste the web add-in, execute a paste operation comprising
pasting the web add-in if the paste target is capable of presenting the web add-in, and
pasting the static image if the paste target is incapable of presenting the web add-in.

20. The computer-readable storage medium of claim 19, wherein the paste target is one of the following:
a new location within the document;
a different document that has been opened using the application;
a different document that has been opened using a different application that is capable of presenting the web add-in; or
a different document that has been opened using a different application that is incapable of presenting the web add-in.
